(19) United States
(12) Patent Application Publication
(10) Pub. No.: US 2013/0087459 A1
(43) Pub. Date: Apr. 11, 2013

(54) DEVICE FOR VARYING WETTING PROPERTIES OF DROPLET AND DEVICE FOR SEPARATING PARTICLES USING THE SAME

(71) Applicant: Kyungpook National University Industry-Academic, (US)

(72) Inventors: Seong Ho Kong, Gyeongsangbuk-do (KR); June Kyoo Lee, Daegu (KR)

(73) Assignee: Kyungpook National University Industry-Academic Cooperation

(21) Appl. No.: 13/645,784

(22) Filed: Oct. 5, 2012

(30) Foreign Application Priority Data
Oct. 6, 2011 (KR) 10-2011-0101978
Oct. 6, 2011 (KR) 10-2011-0101979
Oct. 6, 2011 (KR) 10-2011-0101985

(51) Int. Cl. B01D 57/02; B03C 5/00

(52) U.S. Cl. CPC B01D 57/02; B03C 5/005
USPC 204/643; 204/645

(57) ABSTRACT

Provided are a device for varying wetting properties and a device for separating particles using the same. The magnitude and switching period of a voltage applied to a droplet are changed to separate particles contained in the droplet based on mass or size. The device for varying wetting properties includes an electrode layer that is electrically conductive with one of different electrical polarities, an insulating layer disposed at one side of the electrode layer, and a droplet that is in contact with the other polarity and contains different particles desired to be separated. Wetting properties of the droplet are varied according to application of a voltage.

### CROSS-REFERENCE TO RELATED APPLICATIONS

This U.S. non-provisional patent application claims priority under 35 USC §119 to Korean Patent Application No. 10-2011-0101978, filed on Oct. 6, 2011, No. 10-2011-0101979, filed on filed on Oct. 6, 2011, and No. 10-2011-0101985, filed on Oct. 6, 2011, the entireties of which are hereby incorporated by reference.

### BACKGROUND OF THE INVENTION

The present general inventive concept relates to devices for varying wetting properties of droplet and devices for separating particles using the same.

Wetting properties of a material surface are dependent on a chemical composition or a geometrical structure of the material surface. In general, wet properties of a material surface may be determined by measuring a contact angle to a droplet. Hydrophilic and hydrophobic properties of a droplet surface are determined according to a contact angle of the droplet. For example, a surface of glass has a hydrophilic property when a contact angle of the glass to water is within the range from 5 to 25 degrees while a surface of polydimethylsiloxane has a hydrophobic property when a contact angle of the polydimethylsiloxane to water is 109 degrees.

The wetting properties may be varied by changing chemical and physical properties of a material surface. Exemplarily, hydrophilic or hydrophobic properties of a material surface may be significantly enhanced by making the surface rough. Due to surface wetting properties, complex devices are often required and the size of a sample is unnecessarily restricted.

A method of modifying X-ray induced wettability is disclosed in Korean Patent Publication No. 10-2010-00060460. According to the method disclosed in the Patent, in order to modify wettability of an inorganic material, a surface of the inorganic material is charged with surface charges obtained from optoelectronic emission by irradiating X-ray to the surface of the inorganic material. However, since the method uses X-ray, an additional device configuration is required and a structure becomes complex.

### SUMMARY OF THE INVENTION

Embodiments of the inventive concept provide a device for varying wetting properties and a device for separating particles.

In an aspect of the inventive concept, a device for varying wetting properties may include an electrode layer; and an insulating layer disposed at one side of the electrode layer. A voltage is applied between a droplet disposed on the insulating layer and containing different particles desired to be separated and the electrode layer to vary wetting properties of the droplet.

In an example embodiment, the droplet may migrate to one side according to the magnitude or switching speed of the voltage.

In an example embodiment, the particles contained in the droplet may have different masses.

In another aspect of the inventive concept, a device for varying wetting properties may include a first electrode layer, an insulating layer disposed at one side of the first electrode layer, and a second electrode. A voltage is applied between the first electrode layer and the second electrode layer to vary wetting properties of a droplet disposed between the insulating layer and the second electrode layer and containing different particles desired to be separated.

In an example embodiment, the first electrode layer may be spaced at a predetermined interval.

In an example embodiment, the device for varying wetting properties may further include a hydrophobic layer disposed at one side of the insulating layer and the second electrode layer to increase an initial contact angle of the droplet.

In an example embodiment, the droplet may migrate to one side according to the magnitude or switching speed of the voltage.

In an example embodiment, the particles contained in the droplet may have different masses.

In further another aspect of the inventive concept, a device for separating particles may include a fluid channel including a plurality of first electrodes, an insulating layer disposed at one side of the first electrodes, and a second electrode. A voltage is applied between the first electrode and the second electrode and a droplet disposed between the insulating layer and the second electrode and containing different particles desired to be separated migrates in one side direction to separate the particles contained in the droplet.

In an example embodiment, the particles may be hydrophobic particles.

In an example embodiment, the first electrodes may be spaced apart from each other at predetermined intervals.

In an example embodiment, the droplet migrates to one side according to the magnitude or switching speed of the voltage.

In an example embodiment, the particles contained in the droplet may have different masses.

In an example embodiment, the fluid channel may be circularly formed to allow particles to be separated based on mass by the centrifugal force.

In an example embodiment, the device for separating particles may further include a separation channel connected to one side of the fluid channel and separating a droplet containing particles separated from each other based on mass into droplets having the same mass.

In an example embodiment, the particles may be hydrophobic particles.

In an example embodiment, the device for separating particles may further include a branch channel connected to one side of the fluid channel. The branch channel may have a diameter equivalent to the size of a particle to separate the particle as the droplet migrates.

In an example embodiment, the device for separating particles may further include a valve disposed between the branch channel and the fluid channel.

In an example embodiment, the open and close of the valve may be determined depending on the size of particles desired to be separated.

### BRIEF DESCRIPTION OF THE DRAWINGS

The inventive concept will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the inventive concept.

FIG. 1 illustrates the concept of a device for varying wetting properties according to an embodiment of the inventive concept.

FIG. 2 is a cross-sectional view of a device for varying wetting properties according to an embodiment of the inventive concept.

FIG. 3 is a top plan view of the device for varying wetting properties shown in FIG. 2.

FIG. 4 is a cross-sectional view of a device for varying wetting properties according to another embodiment of the inventive concept.

FIG. 5 is a graphic diagram illustrating speed of revolution of a droplet depending on a driving voltage.

FIG. 6 is a graphic diagram illustrating runtime for forming (separating) particle layers depending on a driving voltage.

FIG. 7 is a graphic diagram illustrating runtime for particle separation depending on a driving voltage.

FIG. 8 is a graphic diagram illustrating a filtering ratio depending on a driving voltage of a droplet.

FIG. 9 illustrates the operation of a device for separating particles according to an embodiment of the inventive concept.

FIG. 10 illustrates the operation of a device for separating particles according to an embodiment of the inventive concept.

FIG. 11 illustrates the operation of a device for separating particles according to further another embodiment of the inventive concept.

FIG. 12 illustrates the magnitude of a centrifugal force depending on the mass of a particle.

### DETAILED DESCRIPTION

The inventive concept will now be described more fully hereinafter with reference to the accompanying drawings, in which embodiments of the invention are shown. The inventive concept may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Now, a device for varying wetting properties of a droplet will be described below in detail.

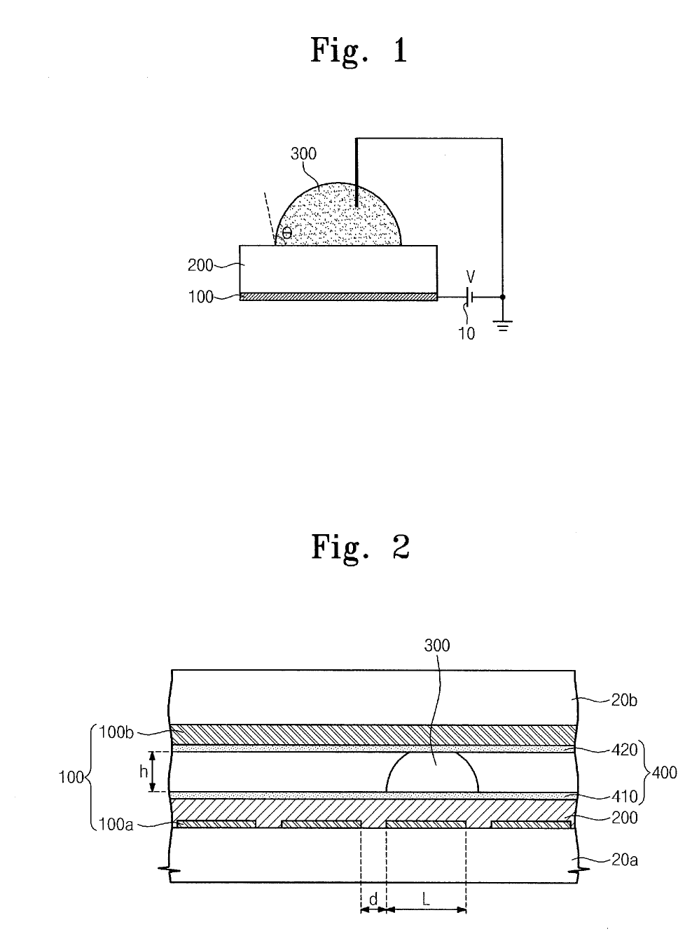

As shown in FIG. 1, a device for varying wetting properties of a droplet includes an electrowetting platform including an electrode layer 100 and an insulating layer 200 and a droplet 300 containing particles with different masses. When a voltage generated by an electrode 10 is applied to the droplet 300, wetting properties of the droplet 300 are varied and the droplet 300 migrates in one side direction.

Hereinafter, the configuration of a device for varying wetting properties of a droplet according to an embodiment of the inventive concept will now be described with reference to FIGS. 2 to 8.

A wetting property defined in the inventive concept indicates the easiness degree of droplet spreading. As shown in FIG. 1, the greater an initial contact angle θ, the less a droplet spreads.

The electrode 10 creates electrically different polarities. A positive (+) polarity is created at one side of the electrode 10, and a negative (−) polarity is created at the other side thereof. As shown in FIG. 1, the positive (+) polarity is connected to the electrode layer 100 and the negative (−) polarity is in contact with the droplet 300 to vary wetting properties of the droplet 300 as a voltage is applied. The applied voltage may be, for example, an AC voltage but is not limited thereto.

A first electrode layer 100a is provided in plurality. As shown in FIG. 2, first electrode layers 100a are spaced apart from each other by a distance d which is an electrode length L. The electrode layers 100a are electrically connected to the positive (+) polarity of the electrode 10. The electrode layers 100a may be a thin film of metal such as Au/Cr or Ni/Cr (Cr being used as an adhesive layer between a meal (Au or Ni) and a glass). In an embodiment of the inventive concept, a thickness of the first electrode layer 100a is about 0.1 to 0.5 micrometer and an electrode interval “d” is about 5 to 50 micrometers.

The insulating layer 200 is disposed on the first electrode layer 100a. The first insulating layer 200 is formed by depositing (coating) an organic thin film such as Teflon AF1600 or Parylene C or an inorganic thin film such as SiO₂ or Si₃N₄ on the first electrode layer 100a. The Teflon AF1600 or Parylene C is allowed to easily quantitatively adjust a thickness of the thin film while exhibiting superior dielectric constant and insulation strength. In the case where the insulating layer 200 is made of Parylene, a thickness of the insulating layer 200 is about 1 micrometer.

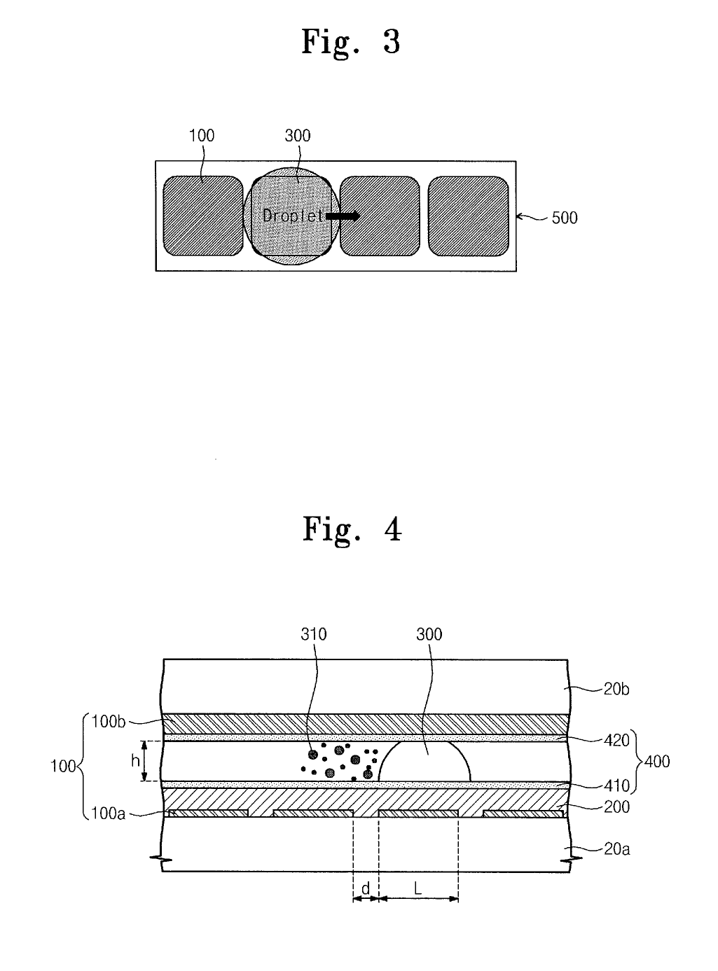

As shown in FIG. 3, a plurality of electrode layers 100 are provided to allow a droplet 300 to migrate in a right direction according to switching of an applied voltage. In addition, migration speed of the droplet 300 may be adjusted according to the intensity and switching speed of the applied voltage.

A hydrophobic layer 400 includes a first hydrophobic layer 410 disposed on a top side surface of the insulating layer 200 and a second hydrophobic layer 420 disposed on a bottom side surface of a second electrode layer 100b that will be explained later. The hydrophobic layer 400 is formed by coating a fluororesin (Teflon AF1600 or Cytop) to a thickness of about 20 nanometers to increase an initial contact angle θ of the droplet 300.

The droplet 300 is disposed between the first hydrophobic layer 410 and the second hydrophobic layer 420 to migrate to one side according to application of a voltage. The droplet 300 contains particles desired to be separated based on mass. In one embodiment of the inventive concept, these particles may have a hydrophilic property to be easily mixed with water and may each have a size ranging from several micrometers to several nanometers.

In one embodiment of the inventive concept, an electrolyte (LiCl, KCl, and MgCl₂) with a concentration of 1 mM is used as conductive liquid, and an insulating solution (silicone oil) or air surrounds an electrolyte drop. The use of the insulating solution is aimed at helping to prevent small-sized drops from falling remaining when the electrolyte drop migrates and being advantageous in forming a large initial contact angle of the electrolyte.

The amount of an electrolyte droplet is determined by a size “L” of a first electrode layer and an interval “h” between first and second hydrophobic layers. As a droplet decreases in size, higher angular velocity may be obtained at the same voltage. In one embodiment of the inventive concept, the interval “h” was about 50 micrometers and a droplet of about 0.5 to 1 microliter was injected.

A second electrode layer 100b is disposed on a top side surface of the second hydrophobic layer 420 as a ground electrode. A glass substrate 20b is disposed on a top side surface of the second electrode layer 100b. The second electrode layer 100b may be made of a transparent electrode such as, for example, ITO.

FIG. 4 is a cross-sectional view illustrating a structure of a device for varying wetting properties. In this embodiment, the particle 310 may have a hydrophobic property. The hydrophobic particle 310 may be a micro- or nano-sized particle. Since the hydrophobic particle 310 cannot be mixed with a droplet 300, the hydrophobic particle 310 may be disposed in front of the migration direction of the droplet 300. As a result, when a voltage is applied to the droplet 300, the droplet 300 pushes the particle 310 and thus the particle 310 may migrate with the droplet 310.

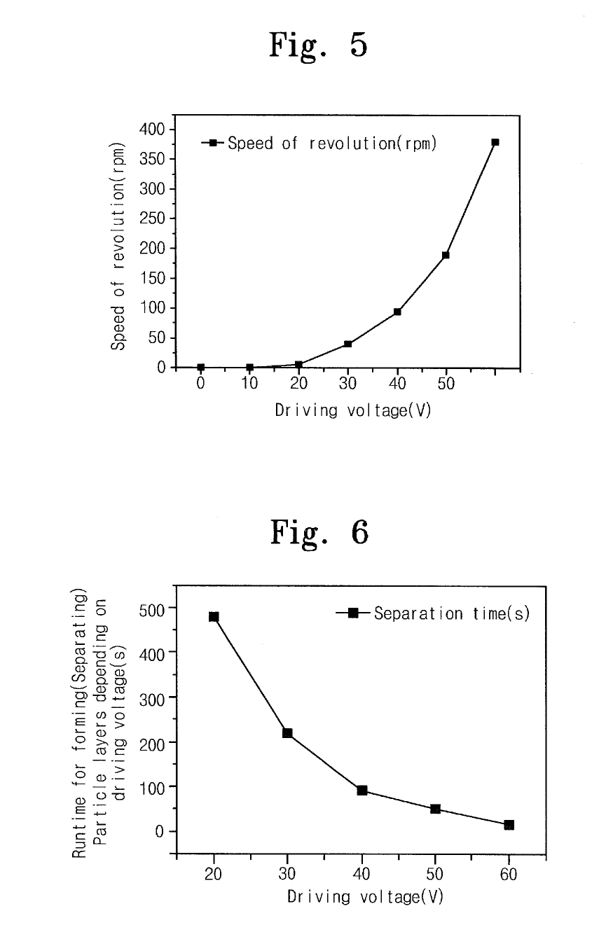

In FIG. 5, revolution speed of a droplet depending on a driving voltage is shown. As shown in FIG. 5, a result of the test conducted according to the foregoing embodiment of the inventive concept was that droplet migration speed of maximum about 100 mm/s was obtained when a voltage of 60 volts was applied and revolution per unit time of about 380 rpm was obtained.

As shown in FIG. 6, time required for separating particles with different masses rapidly decreases as a driving voltage increases. However, since an insulating layer may be damaged at a voltage above 60 volts, a driving voltage of 60 volts is preferably applied.

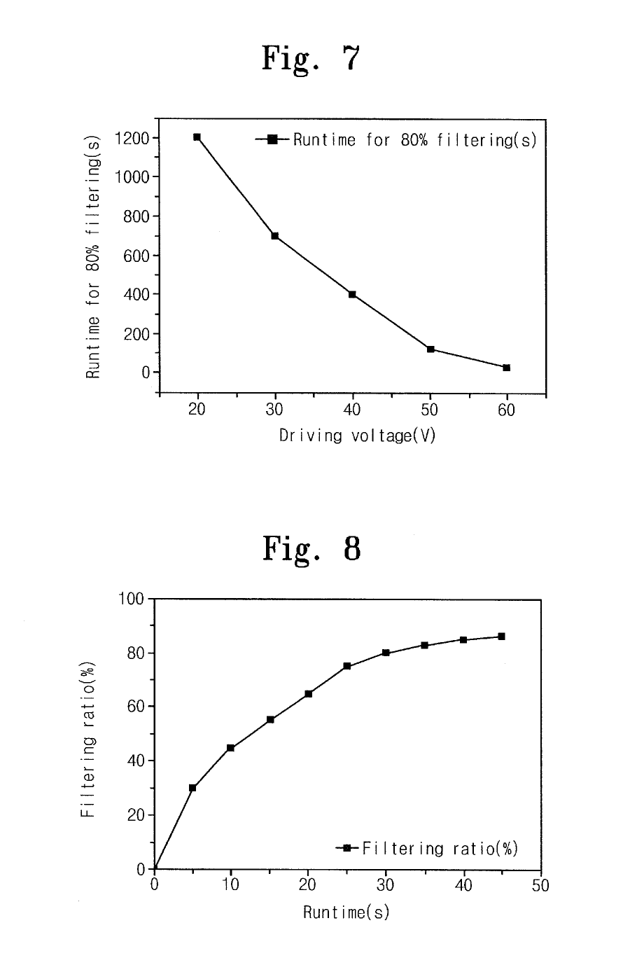

As shown in FIG. 7, time required for filtering particles tends to be in inverse proportion to a driving voltage. A filtering ratio or speed of particles may be in proportion to migration speed of a droplet.

As shown in FIG. 8, a particle filtering ratio tends to increase at the same driving voltage (60 volts) as driving time (revolution) of a droplet increases. However, it will be understood that the particle filtering ratio slowly increases with the lapse of time.

A device for varying wetting properties has been described, and a device for separating particles will now be described in detail hereinafter.

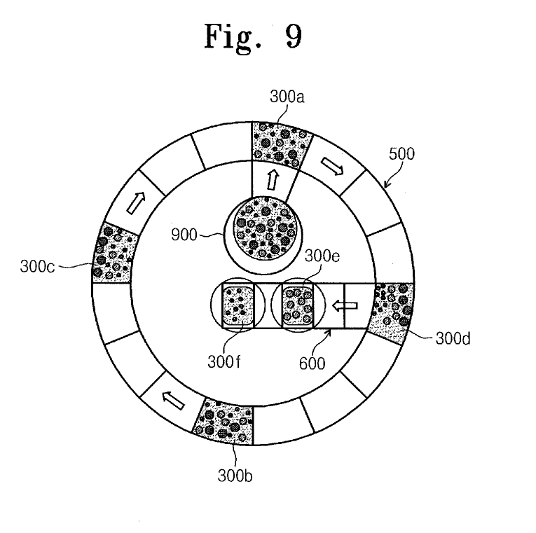

As shown in FIG. 9, a device for separating particles according to an embodiment of the inventive concept includes a fluid channel 500 including first and second electrode layers 100a and 100b (see FIG. 2) and an insulating layer 200 (see FIG. 2). A droplet 300 containing different particles desired to be separated is introduced into the liquid channel 500. The introduced droplet 300 migrates according to application of a voltage, e.g., rotates clockwise along the liquid channel 500 in this figure, allowing particles to be separated based on mass by a centrifuge.

The fluid channel 500 may be integrated with a separation channel 600, as shown in FIG. 9. However, the inventive concept is not limited thereto and the separation channel 600 may be formed individually from the liquid channel 500 before being assembled. The liquid channel 500 may be formed to be circular and include glass substrates 20a and 20b, an electrode layer 100, an insulating layer 200, and a hydrophobic layer 400 which are shown in FIG. 2. As a voltage is applied, the droplet 300 provided between hydrophobic layers 400 rotates clockwise along the liquid channel 500 shown in FIG. 9 to separate particles based on mass.

The order of separating particles contained in a droplet will now be described more specifically. A droplet 300 containing particles desired to be separated is introduced into a liquid channel 500 through an inlet 900. As a voltage is applied, the droplet 300 rotates along the liquid channel 500 in one direction, e.g., clockwise. While the droplet 300 rotates, the particles are separated based on mass by the centrifugal force. For example, the particles are separated from the rotation center of the droplet 300 in the order from small-mass particles to large-mass particles while forming a layer. That is, the particles are rearranged based on mass. In FIG. 9, for example, particles start to be separated based on mass little by little from a droplet 300a through a droplet 300b to a droplet 300c. The particles are finally separated based on mass at a droplet 300d.

Hereinafter, particle separation done through separation of a droplet containing particles separated based on mass will now be described. The separation channel 600 may be connected to one side of the liquid channel 500. The separation channel 600 may have the same configuration as the liquid channel 500. After particles are separated based on mass by rotation of a droplet (see the droplet 300d), voltage application is blocked by the liquid channel 500. When a voltage is applied to the separation channel 600, some of a droplet (e.g., the droplet 300d) containing particles separated based on mass may flows into the separation channel 600. At this point, particles having the same amount as the separated droplet follow the separated droplet. The droplet separation results in particle separation. In this figure, it is shown that the droplet 300d is separated into a droplet 300e and a droplet 300f. The volume of a separated droplet may be adjusted by adjusting characteristics of a voltage applied to the separation channel 600.

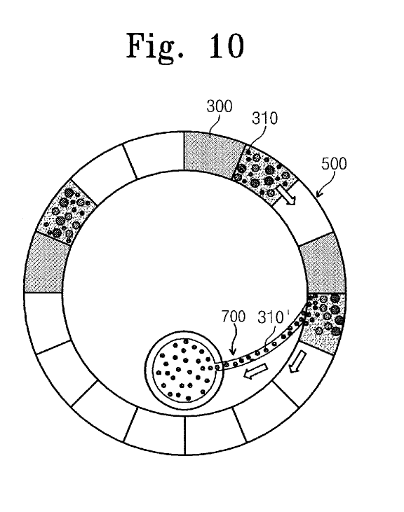

FIG. 10 illustrates the operation of a device for separating particles according to another embodiment of the inventive concept. As shown in FIG. 10, the device for separating particles may include a branch channel 700 formed at one side of a fluid channel 500. The branch channel 700 may be formed at a side surface of the fluid channel 500 which is closer from the center of rotation of particles, i.e., at an inner side surface of the fluid channel 500. Relatively small-mass particles may be disposed at the center of rotation. Namely, small-mass particles are disposed near the center of rotation and large-mass particles are disposed far from the center of rotation due to the centrifugal force generated when particles rotate. Therefore, relatively small-sized particles rotating adjacent to the branch channel 700 may flow into the branch channel 700 to be separated due to droplet revolution. On the other hand, when the branch channel 700 is formed at a side surface of the fluid channel 500 which is far from the center of rotation, i.e., at an outer side surface of the fluid channel 500, relatively large-sized particles rotating far from the center of rotation may flow into the branch channel 700 to be separated due to droplet revolution.

Although particles are not separated based on mass or size by rotation, they may be separated based on type by adjusting a diameter of the branch channel 700. For example, a diameter of the branch channel 700 is made small to allow only particles each having a diameter less than the diameter of the branch channel 700 to be separated based on type. In other words, the branch channel 700 is made to have an inlet size equivalent to a size of particles desired to be separated and thus the particles may be separated while rotating.

In the case where particles have two types of sizes, one branch channel is provided to separate the particles based on size. However, in the case where particles have at least three types of sizes, if necessary, a branch channel may be further provided. The further provided branch channel may be determined considering the size of particles desired to be separated.

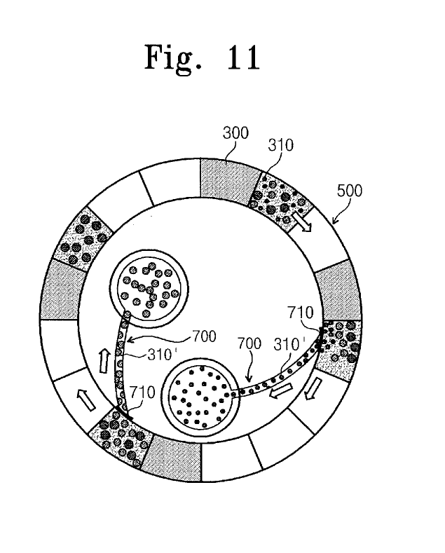

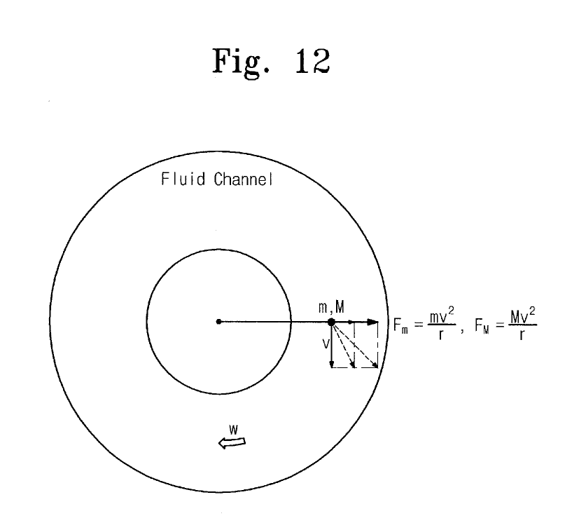

FIG. 11 illustrates the operation of a device for separating particles according to further another embodiment of the inventive concept. As shown in FIG. 11, the device for separating particles may further include a valve 710 at a connection portion between a branch channel 700 and a fluid channel 500 to open or close of an inlet. When a specific particle is separated from a material in which at least three types of particles having different sizes are mixed, the device for separating particles may include a plurality of branch channels 700 to separate one particle per branch channel.

However, although three or more types of particles are mixed, the device for separating particles include one branch channel 700 and further includes a valve between the branch channel 700 and the fluid channel 500 to adjust whether the valve is opened or closed and an open/close ratio of the valve and thus all the particles may be separated. The open/close ratio of the valve may mean a size of opening when the valve is opened.

FIGS. 10 and 11 illustrate particle separating devices for separating hydrophobic particles. However, the particle separating devices are not limited thereto and may be applied to the case where particles are hydrophilic particles.

FIG. 12 illustrates the centrifugal force applied to a particle. The centrifugal force applied to a particle having small mass (m) is less than that applied to a particle having large mass (M). Thus, it will be understood that the particle having small mass (m) is separated near the center of circle and the particle having large mass (M) is centrifugally separated far from the center of circle.

The above-described device for varying wetting properties and the above-described device for separating particles may be manufactured in ultra small size using the MEMS technology. Thus, a lap-on-a-chip device may be implemented.

As described so far, embodiments of the inventive concept may obtain at least one of the effects, as follows. Firstly, a droplet is driven using an electrowetting platform to achieve low power consumption. Secondly, particles contained in a droplet of nanoliter or microliter volume can be separated at high speed. Thirdly, ultra small-sized devices can be manufactured using the MEMS technology. Fourthly, a device for varying wetting properties and a device for separating particles using the same can be combined with other fine fluid components to be readily implemented as a lap-on-a-chip. Lastly, a specific particle can be separated from a material in which various types of particles are mixed.

While the inventive concept has been particularly shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. A device for varying wetting properties, comprising:
an electrode layer; and
an insulating layer disposed at one side of the electrode layer,
wherein a voltage is applied between a droplet disposed on the insulating layer and containing different particles desired to be separated and the electrode layer to vary wetting properties of the droplet.

2. The device for varying wetting properties as forth in claim 1, wherein the droplet migrates to one side according to the magnitude or switching speed of the voltage.

3. The device for varying wetting properties as forth in claim 1, wherein the particles contained in the droplet have different masses.

4. A device for varying wetting properties, comprising:
a first electrode layer, an insulating layer disposed at one side of the first electrode layer, and a second electrode,
wherein a voltage is applied between the first electrode layer and the second electrode layer to vary wetting properties of a droplet disposed between the insulating layer and the second electrode layer and containing different particles desired to be separated.

5. The device for varying wetting properties as forth in claim 4, wherein the first electrode layer is spaced at a predetermined interval.

6. The device for varying wetting properties as forth in claim 4, further comprising:
a hydrophobic layer disposed at one side of the insulating layer and the second electrode layer to increase an initial contact angle of the droplet.

7. The device for varying wetting properties as forth in claim 4, wherein the droplet migrates to one side according to the magnitude or switching speed of the voltage.

8. The device for varying wetting properties as set forth in claim 4, wherein the particles contained in the droplet have different masses.

9. A device for separating particles, comprising:
a fluid channel including a plurality of first electrodes, an insulating layer disposed at one side of the first electrodes, and a second electrode,
wherein a voltage is applied between the first electrode and the second electrode and a droplet disposed between the insulating layer and the second electrode and containing different particles desired to be separated migrates in one side direction to separate the particles contained in the droplet.

10. The device for separating particles as set forth in claim 9, wherein the particles are hydrophobic particles.

11. The device for separating particles as set forth in claim 9, wherein the fluid channel is formed to be circular, and
wherein the particles are separated from each other based on mass by the centrifugal force.

12. The device for separating particles as set forth in claim 9, wherein the first electrodes are spaced apart from each other at predetermined intervals.

13. The device for separating particles as set forth in claim 9, wherein the droplet migrates to one side according to the magnitude or switching speed of the voltage.

14. The device for separating particles as set forth in claim 9, wherein the particles contained in the droplet have different masses.

15. The device for separating particles as set forth in claim 9, further comprising:
a separation channel connected to one side of the fluid channel and separating a droplet containing particles separated from each other based on mass into droplets having the same mass.

16. The device for separating particles as set forth in claim 9, further comprising:
a separation channel connected to one side of the fluid channel,
wherein when a voltage is applied to the separation channel, a droplet included in the fluid channel is separated to flow into the separation channel.

17. The device for separating particles as set forth in claim 9, wherein the particles are hydrophobic particles.

18. The device for separating particles as set forth in claim 9, further comprising:
a branch channel connected to one side of the fluid channel,
wherein the branch channel has a diameter equivalent to the size of a particle to separate the particle as the droplet migrates.

19. The device for separating particles as set forth in claim 18, further comprising:
a valve disposed between the branch channel and the fluid channel.

20. The device for separating particles as set forth in claim 19, wherein the open and close of the valve is determined depending on the size of particles desired to be separated.
